(19) United States
(12) Patent Application Publication
(10) Pub. No.: US 2023/0019279 A1
(43) Pub. Date: Jan. 19, 2023

(54) SYSTEM AND METHOD FOR OPERATING A VARIABLE SPEED COMPRESSOR OF AN AIR CONDITIONER UNIT

(71) Applicant: Haier US Appliance Solutions, Inc., Wilmington, DE (US)

(72) Inventor: Joshua Duane Longenecker, Louisville, KY (US)

(21) Appl. No.: 17/377,713

(22) Filed: Jul. 16, 2021

(51) Int. Cl. F25B 49/02

(52) U.S. Cl. CPC F25B 49/022; F25B 2700/02; F25B 2700/151; F25B 2700/2104; F25B 2600/0253; F25B 2500/08

(57) ABSTRACT

An air conditioner unit includes a variable speed compressor for circulating refrigerant through refrigeration loop and a controller configured to initiate an operating cycle, start a compressor transition timer, and determine an unfiltered compressor speed. The unfiltered compressor speed is fixed based on the selected operating mode until the compressor transition timer reaches a predetermined transition delay time, after which the unfiltered compressor speed is determined using a closed loop feedback control algorithm. The controller is further configured to operate the variable speed compressor at a target compressor speed that is modified from the unfiltered compressor speed based on the identification of a speed modification condition, such as a dehumidification deficiency, a speed restriction, or the identification of one or more resonance avoidance zones.

### FIELD OF THE INVENTION

The present disclosure relates generally to air conditioner units, and more particularly to methods of operating a variable speed compressor of an air conditioner unit.

### BACKGROUND OF THE INVENTION

Air conditioner or conditioning units are conventionally utilized to adjust the temperature indoors, e.g., within structures such as dwellings and office buildings. Such units commonly include a closed refrigeration loop to heat or cool the indoor air. Typically, the indoor air is recirculated while being heated or cooled. A variety of sizes and configurations are available for such air conditioner units. For example, some units may have one portion installed within the indoors that is connected to another portion located outdoors, e.g., by tubing or conduit carrying refrigerant. These types of units are typically used for conditioning the air in larger spaces.

Another type of air conditioner unit, commonly referred to as single-package vertical units (SPVU) or package terminal air conditioners (PTAC), may be utilized to adjust the temperature in, for example, a single room or group of rooms of a structure. These units typically operate like split heat pump systems, except that the indoor and outdoor portions are defined by a bulkhead and all system components are housed within a single package that installed in a wall sleeve positioned within an opening of an exterior wall of a building. When a conventional PTAC is operating in a cooling or heating mode, a compressor circulates refrigerant within a sealed system, while indoor and outdoor fans urges flows of air across indoor and outdoor heat exchangers respectively.

Notably, the speed of the compressor of an air conditioner unit is often varied depending on the conditioning needs of the room. However, certain operating conditions or system characteristics may occur that result in undesirable operating regions for the compressor. For example, the compressor may periodically generate undesirable noise and vibrations that may be disturbing to a room occupant or may result in premature wear and failure of the compressor or other sealed system components. This may be particularly true when the compressor operates at speeds that correspond to the resonant frequencies of the compressor and or other components of air conditioner unit.

In addition, air conditions compressors may periodically operate above various unit power limitations, may generate excessive heat that can affect various unit electronics, or may operate in other regions that are preferably avoided. Moreover, in certain conditions and situations, the target compressor speed may not be sufficient to properly dehumidify the room. Accordingly, the compressor may need to be operated at higher speeds in order to properly cool the indoor heat exchanger to facilitate removal of moisture from the air. Conventional compressor control algorithms do not compensate for such speed modification conditions.

Accordingly, improved air conditioner units and methods of operation to avoid undesirable compressor operating conditions would be useful. More specifically, a packaged terminal air conditioner unit that regulates the compressor operation to avoid operation in resonance zones, zones where power should be limited, or elevated temperature zones would be particularly beneficial.

### BRIEF DESCRIPTION OF THE INVENTION

Aspects and advantages of the invention will be set forth in part in the following description, or may be apparent from the description, or may be learned through practice of the invention.

In one exemplary embodiment, an air conditioner unit is provided including a refrigeration loop comprising an outdoor heat exchanger and an indoor heat exchanger, a variable speed compressor operably coupled to the refrigeration loop and being configured to urge a flow of refrigerant through the outdoor heat exchanger and the indoor heat exchanger, and a controller operably coupled to the variable speed compressor. The controller is configured to initiate an operating cycle and start a compressor transition timer, determine an unfiltered compressor speed based at least in part on the compressor transition timer, identify a speed modification condition, generate a target compressor speed based at least in part on the unfiltered compressor speed and the identification of the speed modification condition, and operate the variable speed compressor at the target compressor speed.

In another exemplary embodiment, a method of operating an air conditioner unit is provided. The air conditioning unit includes a refrigeration loop and a variable speed compressor operably coupled to the refrigeration loop and being configured to urge a flow of refrigerant through the refrigeration loop. The method includes initiating an operating cycle and starting a compressor transition timer, determining an unfiltered compressor speed based at least in part on the compressor transition timer, identifying a speed modification condition, generating a target compressor speed based at least in part on the unfiltered compressor speed and the identification of the speed modification condition, and operating the variable speed compressor at the target compressor speed.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a perspective view of an air conditioner unit, with part of an indoor portion exploded from a remainder of the air conditioner unit for illustrative purposes, in accordance with one exemplary embodiment of the present disclosure.

FIG. 2 is another perspective view of components of the indoor portion of the exemplary air conditioner unit of FIG. 1.

FIG. 3 is a schematic view of a refrigeration loop in accordance with one embodiment of the present disclosure.

FIG. 4 is a rear perspective view of an outdoor portion of the exemplary air conditioner unit of FIG. 1, illustrating a vent aperture in a bulkhead in accordance with one embodiment of the present disclosure.

FIG. 5 is a front perspective view of the exemplary bulkhead of FIG. 4 with a vent door illustrated in the open position in accordance with one embodiment of the present disclosure.

FIG. 6 is a rear perspective view of the exemplary air conditioner unit and bulkhead of FIG. 4 including a fan assembly for providing make-up air in accordance with one embodiment of the present disclosure.

FIG. 7 is a side cross sectional view of the exemplary air conditioner unit of FIG. 1.

FIG. 8 illustrates a method for controlling a variable speed compressor of a packaged terminal air conditioner unit in accordance with one embodiment of the present disclosure.

FIG. 9 illustrates a method for controlling a variable speed compressor of a packaged terminal air conditioner unit in accordance with another embodiment of the present disclosure.

Repeat use of reference characters in the present specification and drawings is intended to represent the same or analogous features or elements of the present invention.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

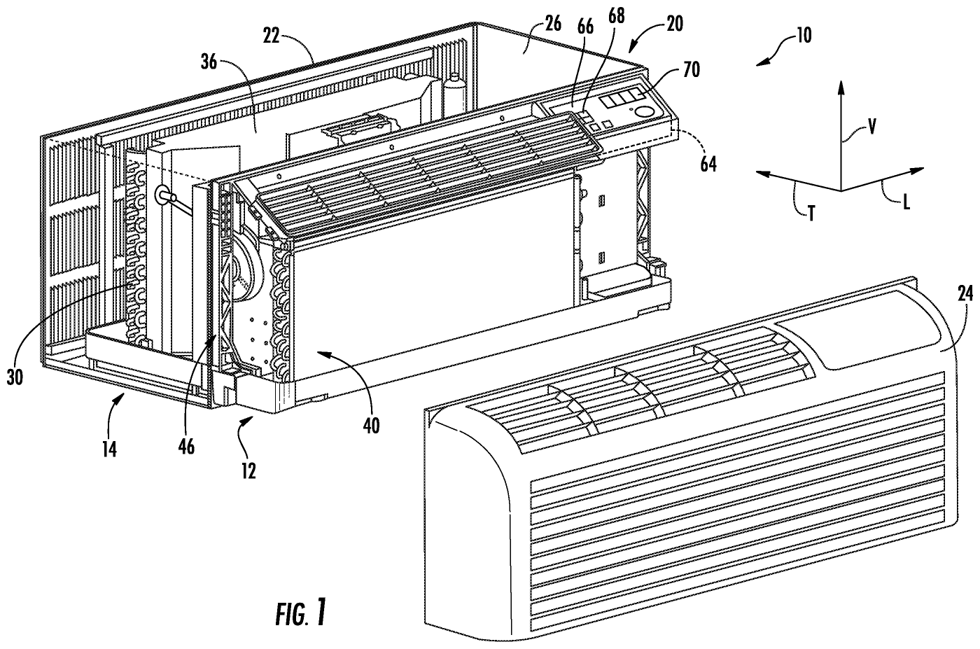

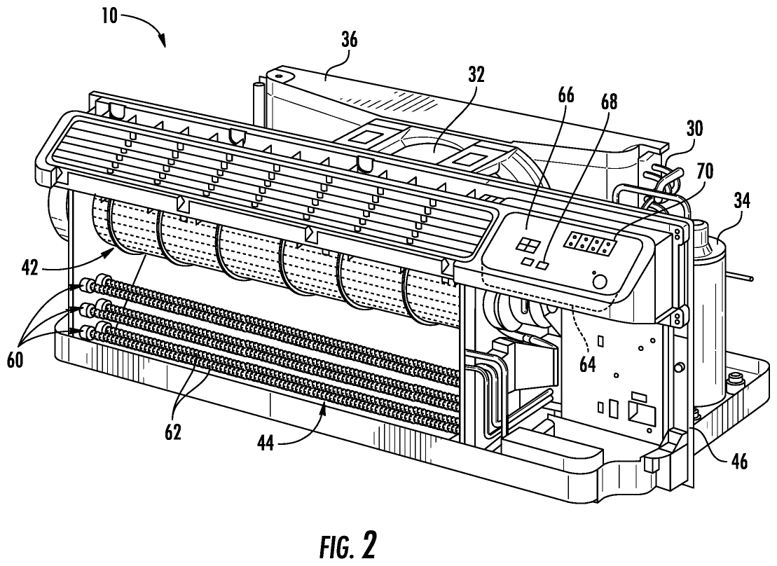

Referring now to FIGS. 1 and 2, an air conditioner unit 10 is provided. The air conditioner unit 10 is a one-unit type air conditioner, also conventionally referred to as a room air conditioner or a packaged terminal air conditioner (PTAC). The unit 10 includes an indoor portion 12 and an outdoor portion 14, and generally defines a vertical direction V, a lateral direction L, and a transverse direction T. Each direction V, L, T is perpendicular to each other, such that an orthogonal coordinate system is generally defined.

A housing 20 of the unit 10 may contain various other components of the unit 10. Housing 20 may include, for example, a rear grill 22 and a room front 24 which may be spaced apart along the transverse direction T by a wall sleeve 26. The rear grill 22 may be part of the outdoor portion 14, and the room front 24 may be part of the indoor portion 12. Components of the outdoor portion 14, such as an outdoor heat exchanger 30, an outdoor fan 32, and a compressor 34 may be housed within the wall sleeve 26. A fan shroud 36 may additionally enclose outdoor fan 32, as shown.

Indoor portion 12 may include, for example, an indoor heat exchanger 40, a blower fan or indoor fan 42, and a heating unit 44. These components may, for example, be housed behind the room front 24. Additionally, a bulkhead 46 may generally support and/or house various other components or portions thereof of the indoor portion 12, such as indoor fan 42 and the heating unit 44. Bulkhead 46 may generally separate and define the indoor portion 12 and outdoor portion 14.

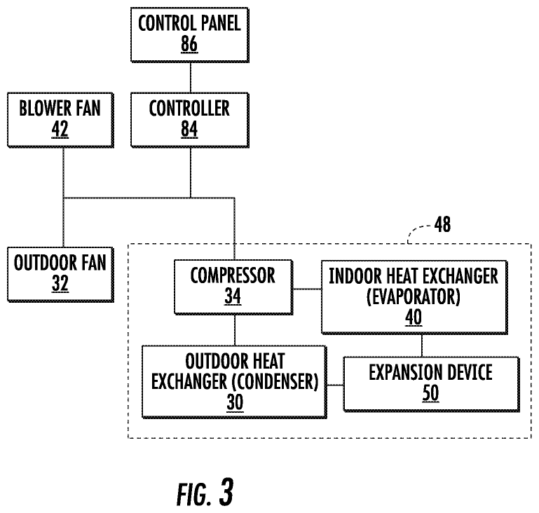

Outdoor and indoor heat exchangers 30, 40 may be components of a sealed system or refrigeration loop 48, which is shown schematically in FIG. 3. Refrigeration loop 48 may, for example, further include compressor 34 and an expansion device 50. As illustrated, compressor 34 and expansion device 50 may be in fluid communication with outdoor heat exchanger 30 and indoor heat exchanger 40 to flow refrigerant therethrough as is generally understood. More particularly, refrigeration loop 48 may include various lines for flowing refrigerant between the various components of refrigeration loop 48, thus providing the fluid communication there between. Refrigerant may thus flow through such lines from indoor heat exchanger 40 to compressor 34, from compressor 34 to outdoor heat exchanger 30, from outdoor heat exchanger 30 to expansion device 50, and from expansion device 50 to indoor heat exchanger 40. The refrigerant may generally undergo phase changes associated with a refrigeration cycle as it flows to and through these various components, as is generally understood. Suitable refrigerants for use in refrigeration loop 48 may include pentafluoroethane, difluoromethane, or a mixture such as R410a, although it should be understood that the present disclosure is not limited to such examples and rather that any suitable refrigerant may be utilized.

As is understood in the art, refrigeration loop 48 may be alternately operated as a refrigeration assembly (and thus perform a refrigeration cycle) or a heat pump (and thus perform a heat pump cycle). As shown in FIG. 3, when refrigeration loop 48 is operating in a cooling mode and thus performing a refrigeration cycle, the indoor heat exchanger 40 acts as an evaporator and the outdoor heat exchanger 30 acts as a condenser. Alternatively, when the assembly is operating in a heating mode and thus performs a heat pump cycle, the indoor heat exchanger 40 acts as a condenser and the outdoor heat exchanger 30 acts as an evaporator. The outdoor and indoor heat exchangers 30, 40 may each include coils through which a refrigerant may flow for heat exchange purposes, as is generally understood.

According to an example embodiment, compressor 34 may be a variable speed compressor. In this regard, compressor 34 may be operated at various speeds depending on the current air conditioning needs of the room and the demand from refrigeration loop 48. For example, according to an exemplary embodiment, compressor 34 may be configured to operate at any speed between a minimum speed, e.g., 1500 revolutions per minute (RPM), to a maximum rated speed, e.g., 3500 RPM. Notably, use of variable speed compressor 34 enables efficient operation of refrigeration loop 48 (and thus air conditioner unit 10), minimizes unnecessary noise when compressor 34 does not need to operate at full speed, and ensures a comfortable environment within the room.

Specifically, according to an exemplary embodiment, compressor 34 may be an inverter compressor. In this regard, compressor 34 may include a power inverter, power electronic devices, rectifiers, or other control electronics suitable for converting an alternating current (AC) power input into a direct current (DC) power supply for the compressor. The inverter electronics may regulate the DC power output to any suitable DC voltage that corresponds to a specific operating speed of compressor. In this manner compressor 34 may be regulated to any suitable operating speed, e.g., from 0% to 100% of the full rated power and/or speed of the compressor. This may facilitate precise compressor operation at the desired operating power and speed, thus meeting system needs while maximizing efficiency and minimizing unnecessary system cycling, energy usage, and noise.

In exemplary embodiments as illustrated, expansion device 50 may be disposed in the outdoor portion 14 between the indoor heat exchanger 40 and the outdoor heat exchanger 30. According to the exemplary embodiment, expansion device 50 may be an electronic expansion valve that enables controlled expansion of refrigerant, as is known in the art. More specifically, electronic expansion device 50 may be configured to precisely control the expansion of the refrigerant to maintain, for example, a desired temperature differential of the refrigerant across the indoor heat exchanger 40. In other words, electronic expansion device 50 throttles the flow of refrigerant based on the reaction of the temperature differential across indoor heat exchanger 40 or the amount of superheat temperature differential, thereby ensuring that the refrigerant is in the gaseous state entering compressor 34. According to alternative embodiments, expansion device 50 may be a capillary tube or another suitable expansion device configured for use in a thermodynamic cycle.

According to the illustrated exemplary embodiment, outdoor fan 32 is an axial fan and indoor fan 42 is a centrifugal fan. However, it should be appreciated that according to alternative embodiments, outdoor fan 32 and indoor fan 42 may be any suitable fan type. In addition, according to an exemplary embodiment, outdoor fan 32 and indoor fan 42 are variable speed fans, e.g., similar to variable speed compressor 34. For example, outdoor fan 32 and indoor fan 42 may rotate at different rotational speeds, thereby generating different air flow rates. It may be desirable to operate fans 32, 42 at less than their maximum rated speed to ensure safe and proper operation of refrigeration loop 48 at less than its maximum rated speed, e.g., to reduce noise when full speed operation is not needed. In addition, according to alternative embodiments, fans 32, 42 may be operated to urge make-up air into the room.

According to the illustrated embodiment, indoor fan 42 may operate as an evaporator fan in refrigeration loop 48 to encourage the flow of air through indoor heat exchanger 40. Accordingly, indoor fan 42 may be positioned downstream of indoor heat exchanger 40 along the flow direction of indoor air and downstream of heating unit 44. Alternatively, indoor fan 42 may be positioned upstream of indoor heat exchanger 40 along the flow direction of indoor air and may operate to push air through indoor heat exchanger 40.

Heating unit 44 in exemplary embodiments includes one or more heater banks 60. Each heater bank 60 may be operated as desired to produce heat. In some embodiments as shown, three heater banks 60 may be utilized. Alternatively, however, any suitable number of heater banks 60 may be utilized. Each heater bank 60 may further include at least one heater coil or coil pass 62, such as in exemplary embodiments two heater coils or coil passes 62. Alternatively, other suitable heating elements may be utilized.

The operation of air conditioner unit 10 including compressor 34 (and thus refrigeration loop 48 generally) indoor fan 42, outdoor fan 32, heating unit 44, expansion device 50, and other components of refrigeration loop 48 may be controlled by a processing device such as a controller 64. Controller 64 may be in communication (via for example a suitable wired or wireless connection) to such components of the air conditioner unit 10. Controller 64 may include a memory and one or more processing devices such as microprocessors, CPUs or the like, such as general or special purpose microprocessors operable to execute programming instructions or micro-control code associated with operation of unit 10. The memory may represent random access memory such as DRAM, or read only memory such as ROM or FLASH. In one embodiment, the processor executes programming instructions stored in memory. The memory may be a separate component from the processor or may be included onboard within the processor.

Unit 10 may additionally include a control panel 66 and one or more user inputs 68, which may be included in control panel 66. The user inputs 68 may be in communication with the controller 64. A user of the unit 10 may interact with the user inputs 68 to operate the unit 10, and user commands may be transmitted between the user inputs 68 and controller 64 to facilitate operation of the unit 10 based on such user commands. A display 70 may additionally be provided in the control panel 66, and may be in communication with the controller 64. Display 70 may, for example be a touchscreen or other text-readable display screen, or alternatively may simply be a light that can be activated and deactivated as required to provide an indication of, for example, an event or setting for the unit 10.

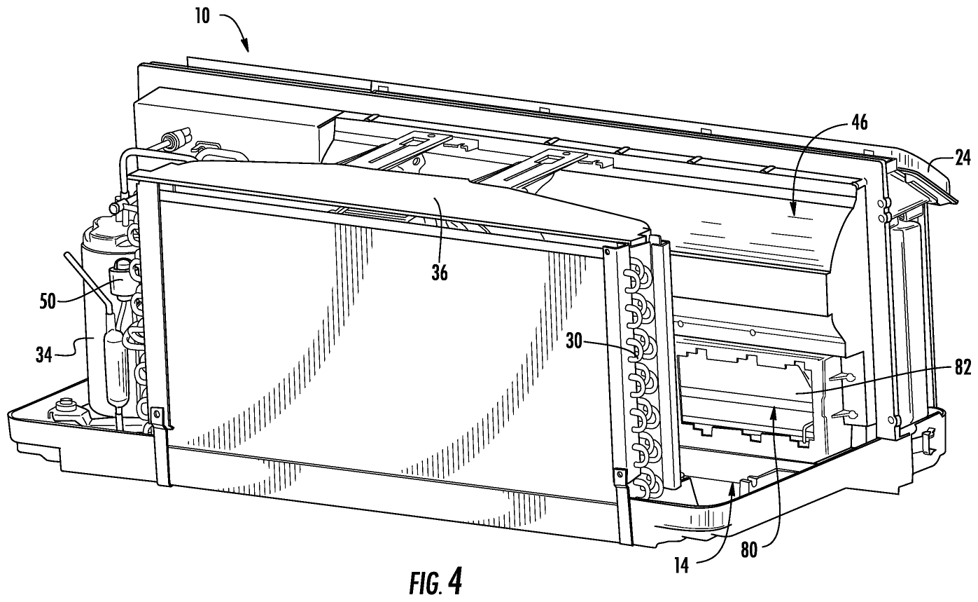

Referring briefly to FIG. 4, a vent aperture 80 may be defined in bulkhead 46 for providing fluid communication between indoor portion 12 and outdoor portion 14. Vent aperture 80 may be utilized in an installed air conditioner unit 10 to allow outdoor air to flow into the room through the indoor portion 12. In this regard, in some cases it may be desirable to allow outside air (i.e., “make-up air”) to flow into the room in order, e.g., to meet government regulations, to compensate for negative pressure created within the room, etc. In this manner, according to an exemplary embodiment, make-up air may be provided into the room through vent aperture 80 when desired.

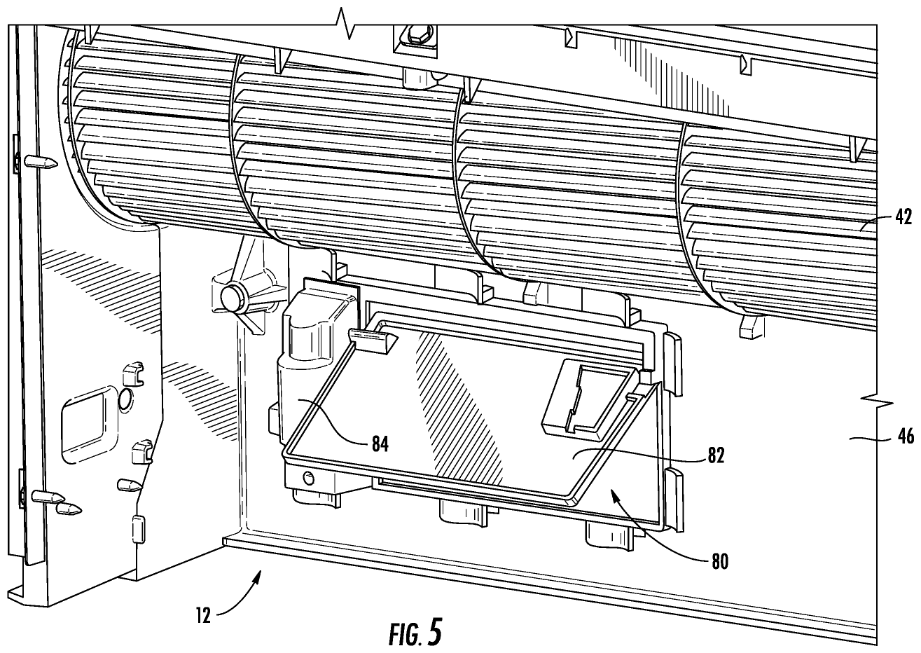

As shown in FIG. 5, a vent door 82 may be pivotally mounted to the bulkhead 46 proximate to vent aperture 80 to open and close vent aperture 80. More specifically, as illustrated, vent door 82 is pivotally mounted to the indoor facing surface of indoor portion 12. Vent door 82 may be configured to pivot between a first, closed position where vent door 82 prevents air from flowing between outdoor portion 14 and indoor portion 12, and a second, open position where vent door 82 is in an open position (as shown in FIG. 5) and allows make-up air to flow into the room. According to the illustrated embodiment vent door 82 may be pivoted between the open and closed position by an electric motor 84 controlled by controller 64, or by any other suitable method.

In some cases, it may be desirable to treat or condition make-up air flowing through vent aperture 80 prior to blowing it into the room. For example, outdoor air which has a relatively high humidity level may require treating before passing into the room. In addition, if the outdoor air is cool, it may be desirable to heat the air before blowing it into the room. Therefore, according to an exemplary embodiment of the present subject matter, unit 10 may further include an auxiliary sealed system that is positioned over vent aperture 80 for conditioning make-up air. The auxiliary sealed system may be a miniature sealed system that acts similar to refrigeration loop 48, but conditions only the air flowing through vent aperture 80. According to alternative embodiments, such as that described herein, make-up air may be urged through vent aperture 80 without the assistance of an auxiliary sealed system. Instead, make-up air is urged through vent aperture 80 may be conditioned at least in part by refrigeration loop 48, e.g., by passing through indoor heat exchanger 40. Additionally, the make-up air may be conditioned immediately upon entrance through vent aperture 80 or sequentially after combining with the air stream induced through indoor heat exchanger 40.

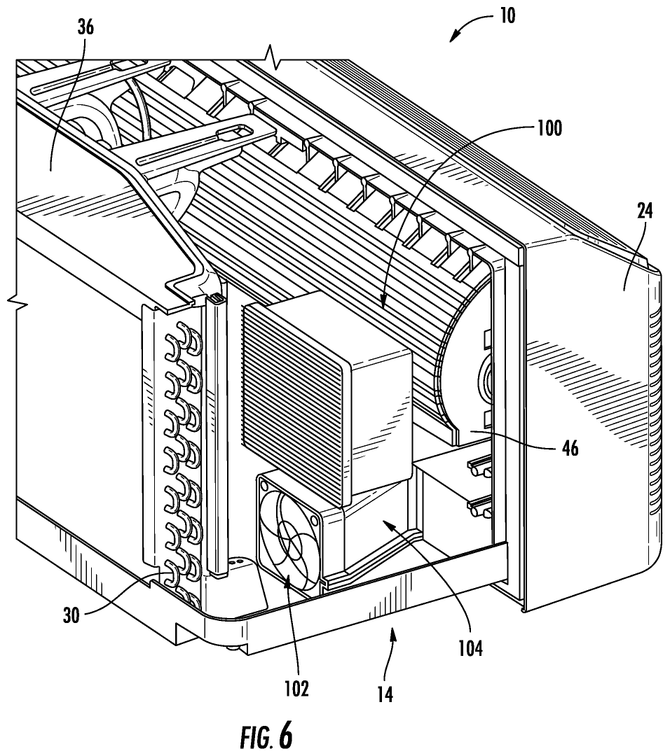

Referring now to FIG. 6, a fan assembly 100 will be described according to an exemplary embodiment of the present subject matter. According to the illustrated embodiment, fan assembly 100 is generally configured for urging the flow of makeup air through vent aperture 80 and into a conditioned room without the assistance of an auxiliary sealed system. However, it should be appreciated that fan assembly 100 could be used in conjunction with a make-up air module including an auxiliary sealed system for conditioning the flow of make-up air. As illustrated, fan assembly 100 includes an auxiliary fan 102 for urging a flow of make-up air through a fan duct 104 and into indoor portion 12 through vent aperture 80.

According to the illustrated embodiment, auxiliary fan 102 is an axial fan positioned at an inlet of fan duct 104, e.g., upstream from vent aperture 80. However, it should be appreciated that any other suitable number, type, and configuration of fan or blower could be used to urge a flow of makeup air according to alternative embodiments. In addition, auxiliary fan 102 may be positioned in any other suitable location within air conditioner unit 10 and auxiliary fan 102 may be positioned at any other suitable location within or in fluid communication with fan duct 104. The embodiments described herein are only exemplary and are not intended to limit the scope present subject matter.

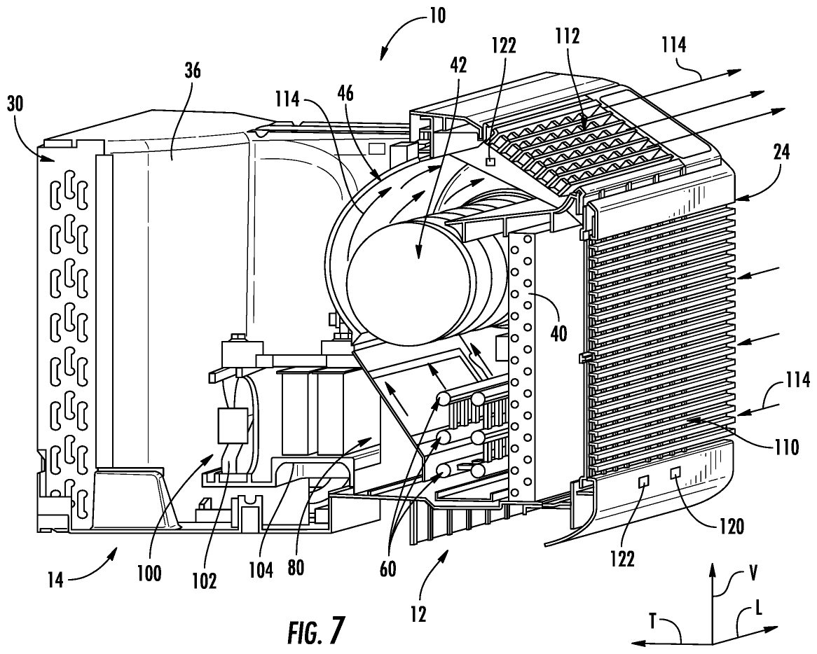

Referring now to FIG. 7, operation of unit 10 will be described according to an exemplary embodiment. More specifically, the operation of components within indoor portion 12 will be described during a cooling operation or cooling cycle of unit 10. To simplify discussion, the operation of auxiliary fan 102 for providing make-up air through vent aperture 80 will be omitted, e.g., as if vent door 82 were closed. Although a cooling cycle will be described, it should be further appreciated that indoor heat exchanger 40 and/or heating unit 44 be used to heat indoor air according to alternative embodiments. Moreover, although operation of unit 10 is described below for the exemplary packaged terminal air conditioner unit, it should be further appreciated that aspects the present subject matter may be used in any other suitable air conditioner unit, such as a heat pump or split unit system.

As illustrated, room front 24 of unit 10 generally defines an intake vent 110 and a discharge vent 112 for use in circulating a flow of air (indicated by arrows 114) throughout a room. In this regard, indoor fan 42 is generally configured for drawing in air 114 through intake vent 110 and urging the flow of air through indoor heat exchanger 40 before discharging the air 114 out of discharge vent 112. According to the illustrated embodiment, intake vent 110 is positioned proximate a bottom of unit 10 and discharge vent 112 is positioned proximate a top of unit 10. However, it should be appreciated that according to alternative embodiments, intake vent 110 and discharge vent 112 may have any other suitable size, shape, position, or configuration.

During a cooling cycle, refrigeration loop 48 is generally configured for urging cold refrigerant through indoor heat exchanger 40 in order to lower the temperature of the flow of air 114 before discharging it back into the room. Specifically, during a cooling operation, controller 64 may be provided with a target temperature, e.g., as set by a user for the desired room temperature. In general, components of refrigeration loop 48, outdoor fan 32, indoor fan 42, and other components of unit 10 operate to continuously cool the flow of air.

In order to facilitate operation of refrigeration loop 48 and other components of unit 10, unit 10 may include a variety of sensors for detecting conditions internal and external to the unit 10. These conditions can be fed to controller 64 which may make decisions regarding operation of unit 10 to rectify undesirable conditions or to otherwise condition the flow of air 114 into the room. For example, as best illustrated in FIG. 7, unit 10 may include an indoor temperature sensor 120 which is positioned and configured for measuring the indoor temperature within the room. In addition, unit 10 may include an indoor humidity sensor 122 which is positioned and configured for measuring the indoor humidity within the room. In this manner, unit 10 may be used to regulate the flow of air 114 into the room until the measured indoor temperature reaches the desired target temperature and/or humidity level.

As used herein, “temperature sensor” or the equivalent is intended to refer to any suitable type of temperature measuring system or device positioned at any suitable location for measuring the desired temperature. Thus, for example, temperature sensor 120 may each be any suitable type of temperature sensor, such as a thermistor, a thermocouple, a resistance temperature detector, a semiconductor-based integrated circuit temperature sensors, etc. In addition, temperature sensor 120 may be positioned at any suitable location and may output a signal, such as a voltage, to a controller that is proportional to and/or indicative of the temperature being measured. Although exemplary positioning of temperature sensors is described herein, it should be appreciated that unit 10 may include any other suitable number, type, and position of temperature, humidity, and/or other sensors according to alternative embodiments.

As used herein, the terms “humidity sensor” or the equivalent may be intended to refer to any suitable type of humidity measuring system or device positioned at any suitable location for measuring the desired humidity. Thus, for example, humidity sensor 122 may refer to any suitable type of humidity sensor, such as capacitive digital sensors, resistive sensors, and thermal conductivity humidity sensors. In addition, humidity sensor 122 may be positioned at any suitable location and may output a signal, such as a voltage, to a controller that is proportional to and/or indicative of the humidity being measured. Although exemplary positioning of humidity sensors is described herein, it should be appreciated that unit 10 may include any other suitable number, type, and position of humidity sensors according to alternative embodiments.

Now that the construction of air conditioner unit 10 and the configuration of controller 64 according to exemplary embodiments have been presented, exemplary methods 200, 300 of operating a packaged terminal air conditioner unit will be described. Although the discussion below refers to the exemplary methods 200, 300 of operating air conditioner unit 10, one skilled in the art will appreciate that the exemplary methods 200, 300 are applicable to the operation of a variety of other air conditioning appliances. In exemplary embodiments, the various method steps as disclosed herein may be performed by controller 64 or a separate, dedicated controller.

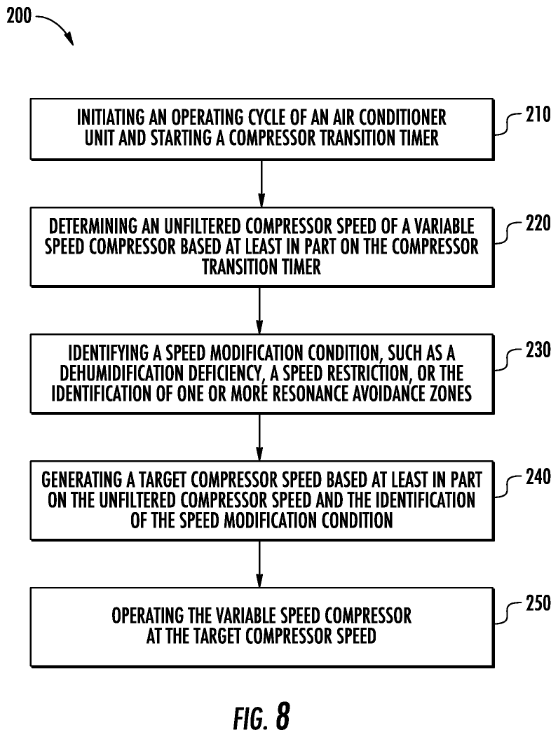

Referring now to FIG. 8, method 200 includes, at step 210, initiating an operating cycle of an air conditioner unit. In this regard, for example, air conditioner unit 10 may be triggered to begin performing an air conditioning process, e.g., by selectively operating compressor 34, outdoor fan 32, indoor fan 42, etc. to facilitate heat pump operation and the heating or cooling of indoor air 114. The initiation of an operating cycle may be triggered by any suitable source, in any suitable manner, and may correspond with any suitable sealed system demand, as described below according to exemplary embodiments.

In this regard, for example, an operating cycle may be initiated by a thermostat based at least in part on a difference between a measured temperature (e.g., as measured by indoor temperature sensor 120) and a temperature setpoint of the air-conditioned room. In this regard, if the measured temperature differs from the temperature set point by more than a predetermined amount, unit 10 may initiate an operating cycle to urge the measured temperature toward the temperature setpoint. According to exemplary embodiments, the operating cycle may also be directly initiated by a user of unit 10, e.g., via manipulation of control panel 66.

According to exemplary embodiments, a sealed system demand may vary depending on the heating or cooling capacity needs within a particular room. In general, the sealed system demand may generally vary proportionally with the corresponding sealed system component speeds and the desired rate of temperature change. In this regard, a higher sealed system demand may correspond to increased compressor speeds, increased fan speeds, etc. to improve the ability of unit 10 to condition the room quickly. By contrast, a lower sealed system demand may correspond to decreased compressor speeds, fan speeds, etc., e.g., when the measured temperature is close to the target temperature and lower power consumption and noise generation are desirable.

It should be appreciated that according to exemplary embodiments, the heating/cooling capacity or sealed system demand may vary based on the magnitude of temperature difference between the measured temperature and the target temperature or the temperature setpoint. Thus, for example, if the temperature differential exceeds a lower differential threshold (e.g., plus or minus 2 degrees Fahrenheit), an operating cycle may be initiated where the sealed system demand is low (e.g., a low-level operating cycle where compressor 34, an outer fan 32, and indoor fan 42 operate at lower speeds). By contrast, if the temperature differential exceeds a higher differential threshold (e.g., plus or minus 4 degrees Fahrenheit), the sealed system demand may be high (e.g., a high-level operating cycle where compressor 34 outdoor fan 32, and indoor fan 42 operate at higher speeds).

According to still other embodiments, the heating or cooling capacity of an operating cycle or the sealed system demand may be directly manipulated by a user of unit 10. In this regard, for example, a user may directly manipulate control panel 66 to increase or decrease the intensity of an operating cycle or the sealed system demand. Thus, if a user wishes to quickly cool a room, the user may select a user input 68 that corresponds to a maximum cooling capacity or the highest-level of sealed system demand. It should be appreciated that the operating cycle may be performed in an open-ended manner or may rely on temperature and humidity feedback (e.g., received the indoor temperature sensor 120 and/or indoor humidity sensor 122).

Notably, at the commencement of an operating cycle when compressor 34 first begins circulating the flow of refrigerant within refrigeration loop 48, unit 10 may have little or no effect on the temperature within the air-conditioned room. Specifically, it may take a few minutes for the cooling capacity of the sealed system to take effect. Accordingly, it may be undesirable to immediately begin operating the sealed system in a closed loop manner, as this may result in undesirably high operating speeds. Accordingly, step 210 may include starting a compressor transition timer, e.g., simultaneously with starting the compressor 34. As will be described in more detail below, the compressor speed of variable speed compressor 34 may be determined at least in part based on the compressor transition timer.

Specifically, step 220 generally includes determining an unfiltered compressor speed of the variable speed compressor based at least in part on the compressor transition timer. As used herein, the “unfiltered compressor speed” may refer generally to a target compressor speed based primarily on sealed system capacity (e.g., how quickly the room should be heated/cooled). In this regard, for example, at the initiation of the operating cycle, variable speed compressor 34 may be operated at a fixed compressor speed. As noted above, the fixed compressor speed may vary based on the sealed system demand, e.g., the heating or cooling capacity demanded from unit 10. In this regard the sealed system demand may be at a low level, a high-level, an intermediate level, or any other suitable operating level, and the fixed compressor speed may vary accordingly.

For example, at the commencement of an operating cycle when a temperature differential between the measured temperature and the setpoint temperature is relatively small, the sealed system demand may be low. Accordingly, the fixed compressor speed may be between about 800 and 2800 revolutions per minute, between about 1000 and 2600 revolutions per minute, between about 1200 and 2400 revolutions per minute, between about 1500 and 2100 revolutions per minute, or about 1800 revolutions per minute.

By contrast, if the temperature differential between the measured temperature and the setpoint temperature is relatively large at the commencement of an operating cycle, sealed system demand may be high. Accordingly, the fixed compressor speed may be between about 2600 and 4600 revolutions per minute, between about 2800 and 4400 revolutions per minute, between about 3000 and 4200 revolutions per minute, between about 3300 and 3900 revolutions per minute, or about 3600 revolutions per minute. It should be appreciated that these fixed operating speeds are only exemplary and may vary while remaining within scope the present subject matter. In addition, it should be appreciated that although only two operating modes or levels are described, unit 10 may operate at any other suitable intermediate operating levels while remaining within scope the present subject matter.

Notably, after the sealed system begins properly heating/cooling the room, it may be desirable to transition to a more active, closed loop control system. In this regard, the closed-loop control system may rely on temperature and/or humidity feedback from one or more system sensors (e.g., such as indoor temperature sensor 120 and indoor humidity sensor 122). Accordingly, method 200 may further include determining that the compressor transition timer (e.g., initiated at the start of the operating cycle in step 210) has exceeded a predetermined transition delay time. In general, the predetermined transition delay time may correspond to the amount of time it takes for the sealed system to begin effectively heating or cooling the room. This predetermined transition delay time may be set by the user or manufacturer, ma be determined empirically, or may be set in any other suitable manner. For example, according to exemplary embodiments, the predetermined transition delay time may be between about 30 seconds and 10 minutes, between about 1 minute and 5 minutes, between about 2 minutes and 4 minutes, or about 3 minutes. Other transition delay times are possible and within the scope of the present subject matter.

Notably, step 220 of determining the unfiltered compressor speed of the variable speed compressor based at least in part on the current compressor transition timer may include determining the unfiltered compressor speed based on the closed-loop feedback control algorithms upon determining that the compressor transition timer has exceeded the predetermined transition delay time. For example, according to exemplary embodiments, the closed-loop feedback control algorithm may include a proportional control algorithm, a proportional-integral control algorithm (e.g., a PI controller), or a proportional-integral-derivative control algorithm (e.g., a PID controller).

In general, the closed-loop feedback control algorithm may operate compressor 34 to minimize a difference between the measured indoor temperature and a setpoint temperature. In this regard, implementation of the closed-loop feedback control algorithm may include obtaining an indoor temperature (e.g., using indoor temperature sensor 120), determining an error value between the indoor temperature and a setpoint temperature, and passing or inputting error value into the closed-loop feedback control algorithm to generate an unfiltered compressor speed as a control input that minimizes the error. Details regarding the operation of the closed-loop feedback control algorithm are generally well known in the art and further detailed discussion will be omitted here for brevity.

Notably, step 220 generally generates an unfiltered compressor speed which may generally correspond to the desired speed of the variable speed compressor 34 for efficiently heating, cooling, and/or dehumidifying a room where unit 10 is positioned. However, certain conditions may exist or certain operating characteristics may occur during operation of unit 10 that may make it desirable to modify the unfiltered compressor speed. Accordingly, step 230 may generally includes identifying a speed modification condition, such as a dehumidification deficiency, a speed restriction, or the identification of one or more resonance avoidance zones, each of which will be described in more detail below.

In addition, step 240 may include generating a target compressor speed based at least in part on the unfiltered compressor speed and the identification of the speed modification condition. According to an exemplary embodiment, step 250 may include operating the variable speed compressor at the target compressor speed. Notably, the target compressor speed may be modified from the unfiltered compressor speed and such modification may depend on the speed modification condition detected at step 230. Various speed modification conditions and their corresponding effects on the unfiltered compressor speed will be described below according to exemplary embodiments of the present subject matter. However, it should be appreciated that other speed modification conditions are possible and within the scope of the present subject matter.

According to exemplary embodiments, identification of the speed modification condition may generally include identifying a dehumidification deficiency. In this regard, a dehumidification deficiency may generally refer to situations where the room is not being properly dehumidified by unit 10 or when a dehumidification process is otherwise inefficient or not performing is desired. For example, method 200 may include measuring a humidity of the room being conditioned (e.g., using indoor humidity sensor 122) and determining that the measured humidity exceeds a predetermined humidity threshold. According to alternative embodiments, unit 10 may use indoor humidity sensor 122 identify a dehumidification rate and may compare that dehumidification rate to a target dehumidification rate to determine whether unit 10 is properly dehumidifying the room.

As noted above, a dehumidification deficiency may arise, for example, in certain conditions where compressor 34 needs to be operated at higher speeds in order to properly cool the indoor heat exchanger to facilitate removal of moisture from the air. Thus, if the unfiltered compressor speed (e.g., determined at step 220) is too low to facilitate this dehumidification process, the identification of the dehumidification deficiency may result in the implementation of a floor or lower speed boundary of compressor 34. Accordingly, the target compressor speed may be increased relative to the unfiltered compressor speed, e.g., being set to the lower speed boundary set as a result of the identification of the dehumidification deficiency. More specifically, for example, if the unfiltered compressor speed is calling for compressor 34 to run at 2000 RPM, but a dehumidification deficiency is identified that requires the compressor speed to operate at a minimum of 2400 RPM, the target compressor speed may be set to 2400 RPM instead of 2000 RPM. In this manner, the lower speed boundary resulting from the dehumidification deficiency may act as a lower limit of the unfiltered compressor speed.

According to another exemplary embodiments, identifying a speed modification condition may include identifying a speed restriction or a power limiting state of compressor 34. In this regard, certain operating conditions may arise where it is undesirable to maintain a high speed of compressor 34. For example, a speed restriction may be implemented if a power consumption limit of compressor 34 has been exceeded, a control board temperature has risen to an undesirably high level, or another unit operating characteristic indicates that the compressor speed should be lowered or limited to a particular speed. Accordingly, when the speed restriction is identified, the unfiltered compressor speed (e.g., determined at step 220) be limited to the upper speed boundary corresponding to the speed restriction. Specifically, for example, if the unfiltered compressor speed is 5000 RPM and inverter board temperatures begin to elevate above a predetermined temperature threshold, the unfiltered compressor speed may be reduced to a predetermined value, e.g., such as 4000 to 4500 RPM to prevent overheating of the inverter control board.

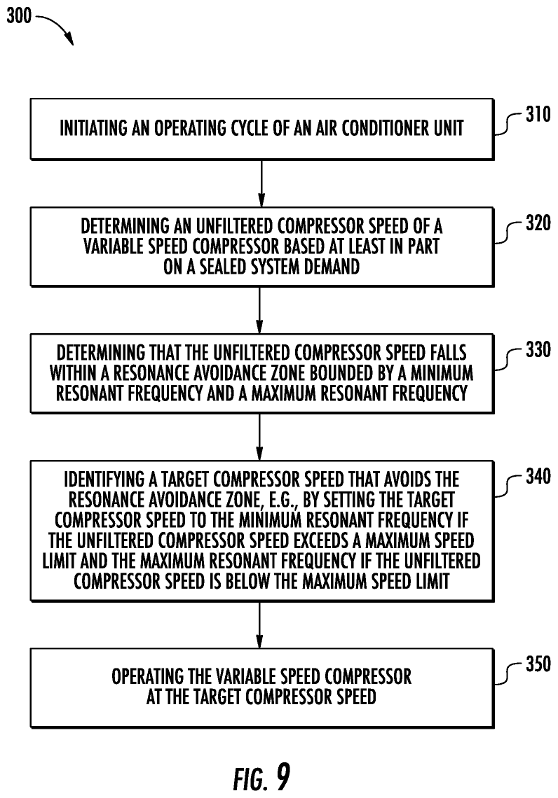

According to still other embodiments, the identification of the speed modification condition may include identifying one or more resonance avoidance zones. If the unfiltered compressor speed falls within the one or more resonance avoidance zones, the unfiltered compressor speed may be adjusted to fall outside of those zones. For example, the resonance avoidance zones may generally correspond to operating speeds or frequencies that generate excessive vibration within compressor 34, sealed system, or unit 10 more generally. If left unchecked, these vibrations may result in degradation of system components and premature failure of unit 10. Details regarding an exemplary method of adjusting the unfiltered compressor speed to avoid one or more resonance avoidance zones will be described in more detail with reference to FIG. 9. It should be appreciated that the various steps within methods 200 (FIG. 8) and 300 (FIG. 9) may be interchangeable, combinable, and variable in order to generate additional methods of operating an air conditioner unit.

Referring now to FIG. 9, method 300 includes, at step 310, initiating an operating cycle of an air conditioner unit. Step 320 may include determining an unfiltered compressor speed of the variable speed compressor based at least in part on a sealed system demand. For example, as explained above with reference to steps 210 and 220, unit 10 may receive a command to initiate an operating cycle and may initiate sealed system operation in response to a sealed system demand which may be low for small temperature differentials, high for larger temperature differentials, or may include any other suitable sealed system demand and corresponding operating speeds and parameters of unit 10.

Step 330 may include determining that the unfiltered compressor speed falls within a resonance avoidance zone bounded by a minimum resonant frequency and a maximum resonant frequency. In this regard, the resonance avoidance zone may be a band of operating frequencies of compressor 34 that may generate undesirable vibrations within unit 10. For example, a resonance avoidance zone may be defined as compressor operating speeds between 2600 and 2800 RPM, or any other range of operating speeds. Thus, it may be generally desirable to avoid operating compressor 34 in that operating zone. Notably, when no other restrictions are present, it may be desirable to default the compressor operating speed to the high side of the resonance avoidance zone, e.g., at the maximum resonant frequency. However, according to exemplary embodiments, other system operating parameters or characteristics may make operation at the maximum resonant frequency undesirable.

For example, if a speed restriction or power restriction has been identified or triggered in the operation of unit 10, and if the maximum resonant frequency exceeds the identified speed or power restriction, it may instead be desirable to set the compressor speed based on the minimum resonant frequency. Accordingly, step 340 may include identifying a target compressor speed that avoids the resonance avoidance zone. Specifically, step 340 may include setting the target compressor speed to the minimum resonant frequency if the unfiltered compressor speed exceeds a maximum speed limit. In addition, step 340 may include setting the target compressor speed to the maximum resonant frequency if the unfiltered compressor speed is below the maximum speed limit.

Specifically, for example, if the unfiltered compressor speed is 3000 RPM, a resonance avoidance zone is identified between 2900 and 3100 RPM, and there is no power limiting value (or a power limit that is above the maximum resonant frequency of 3100 RPM, such as 4000 RPM), the target compressor speed may be set to 3100 RPM. By contrast, if the unfiltered compressor speed is 4000 RPM, a resonance avoidance zone is identified between 3900 and 4200 RPM, and a power limit has been set at 4100 RPM, then the target compressor speed may be set to 3900 RPM in order to avoid the resonance avoidance zone and the power limited range. Step 350 may generally include operating the variable speed compressor at the target compressor speed. Notably, implementing method 300 may generally facilitate operation of compressor 34 and unit 10 in a manner that efficiently cools or heats a room without generating excessive noise or harmful vibrations, and without exceeding power limits to protect system components.

Although method 300 is described herein as facilitating operation of compressor 34 to avoid a single resonance avoidance zone, it should be appreciated that unit 10 may have more than one residence avoidance zone. Accordingly, method 300 may include operating compressor 34 to avoid each of the residence avoidance zones. In addition, it should be appreciated that these resonance avoidance zones may be programmed by a user or maintenance technician of air conditioner unit. In this regard, these zones may be empirically determined in may be programmed into controller to facilitate improved future performance of unit 10.

FIGS. 8 and 9 depict steps performed in a particular order for purposes of illustration and discussion. Those of ordinary skill in the art, using the disclosures provided herein, will understand that the steps of any of the methods discussed herein can be adapted, rearranged, expanded, omitted, or modified in various ways without deviating from the scope of the present disclosure. Moreover, although aspects of method 200 and method 300 are explained using unit 10 as an example, it should be appreciated that this method may be applied to operate any suitable air conditioner unit.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

1. An air conditioner unit comprising:
a refrigeration loop comprising an outdoor heat exchanger and an indoor heat exchanger;
a variable speed compressor operably coupled to the refrigeration loop and being configured to urge a flow of refrigerant through the outdoor heat exchanger and the indoor heat exchanger; and
a controller operably coupled to the variable speed compressor, the controller being configured to:
initiate an operating cycle and start a compressor transition timer;
determine an unfiltered compressor speed based at least in part on the compressor transition timer, the unfiltered compressor speed being based at least in part on a temperature differential between a target room temperature and a measured room temperature;
identify a speed modification condition;
generate a target compressor speed based at least in part on the unfiltered compressor speed and the identification of the speed modification condition; and
operate the variable speed compressor at the target compressor speed.

2. The air conditioner unit of claim 1, wherein determining the unfiltered compressor speed based at least in part on the compressor transition timer comprises:
operating the variable speed compressor at a fixed compressor speed;
determining that the compressor transition timer has exceeded a predetermined transition delay time; and
determining the unfiltered compressor speed based at least in part on a closed loop feedback control algorithm in response to determining that the compressor transition timer has exceeded the predetermined transition delay time.

3. The air conditioner unit of claim 2, wherein the fixed compressor speed is between 1200 and 2400 revolutions per minute when a sealed system demand for the operating cycle is a low heating or cooling mode.

4. The air conditioner unit of claim 2, wherein the fixed compressor speed is about 1800 revolutions per minute when a sealed system demand for the operating cycle is a low heating or cooling mode.

5. The air conditioner unit of claim 2, wherein the fixed compressor speed is between 3000 and 4200 revolutions per minute when a sealed system demand for the operating cycle is a high heating or cooling mode.

6. The air conditioner unit of claim 2, wherein the fixed compressor speed is about 3600 revolutions per minute when a sealed system demand for the operating cycle is a high heating or cooling mode.

7. The air conditioner unit of claim 2, wherein the predetermined transition delay time is between two and four minutes.

8. The air conditioner unit of claim 2, wherein the closed loop feedback control algorithm comprises a proportional control algorithm, a proportional-integral control algorithm, or a proportional-integral-derivative control algorithm.

9. The air conditioner unit of claim 2, further comprising an indoor temperature sensor, wherein determining the target compressor speed based at least in part on the closed loop feedback control algorithm comprises:
obtaining an indoor temperature using the indoor temperature sensor;
determining an error value between the indoor temperature and a setpoint temperature; and
passing the error value into the closed loop feedback control algorithm to determine the unfiltered compressor speed.

10. The air conditioner unit of claim 1, wherein identifying the speed modification condition comprises identifying a dehumidification deficiency, and wherein generating the target compressor speed based at least in part on the unfiltered compressor speed and the identification of the speed modification condition comprises:
limiting the unfiltered compressor speed at a lower speed boundary based on the identification of the dehumidification deficiency.

11. The air conditioner unit of claim 10, wherein identifying the dehumidification deficiency comprises:
measuring a humidity using a humidity sensor; and
determining that the humidity exceeds a predetermined humidity threshold.

12. The air conditioner unit of claim 1, wherein identifying the speed modification condition comprises identifying a speed restriction, and wherein generating the target compressor speed based at least in part on the unfiltered compressor speed and the identification of the speed modification condition comprises:
limiting the unfiltered compressor speed at an upper speed boundary based on the identification of the speed restriction.

13. The air conditioner unit of claim 12, wherein identifying the speed restriction comprises at least one of determining that a power consumption limit has been exceeded or determining that a control board temperature has exceeded a temperature threshold.

14. The air conditioner unit of claim 1, wherein identifying the speed modification condition comprises identifying one or more resonance avoidance zones, and wherein generating the target compressor speed based at least in part on the unfiltered compressor speed and the identification of the speed modification condition comprises:
adjusting the unfiltered compressor speed to avoid the one or more resonance avoidance zones.

15. A method of operating an air conditioner unit, the air conditioning unit comprising a refrigeration loop and a variable speed compressor operably coupled to the refrigeration loop and being configured to urge a flow of refrigerant through the refrigeration loop, the method comprising:
initiating an operating cycle and starting a compressor transition timer;
determining an unfiltered compressor speed based at least in part on the compressor transition timer, the unfiltered compressor speed being based at least in part on a temperature differential between a target room temperature and a measured room temperature;
identifying a speed modification condition;
generating a target compressor speed based at least in part on the unfiltered compressor speed and the identification of the speed modification condition; and
operating the variable speed compressor at the target compressor speed.

16. The method of claim 15, wherein determining the unfiltered compressor speed based at least in part on the compressor transition timer comprises:
operating the variable speed compressor at a fixed compressor speed;
determining that the compressor transition timer has exceeded a predetermined transition delay time; and
determining the unfiltered compressor speed based at least in part on a closed loop feedback control algorithm in response to determining that the compressor transition timer has exceeded the predetermined transition delay time.

17. The method of claim 16, wherein the fixed compressor speed is between 1200 and 2400 revolutions per minute when a sealed system demand for the operating cycle is a low heating or cooling mode, and wherein the fixed compressor speed is between 3000 and 4200 revolutions per minute when a sealed system demand for the operating cycle is a high heating or cooling mode.

18. The method of claim 15, wherein identifying the speed modification condition comprises identifying a dehumidification deficiency, and wherein generating the target compressor speed based at least in part on the unfiltered compressor speed and the identification of the speed modification condition comprises:
limiting the unfiltered compressor speed at a lower speed boundary based on the identification of the dehumidification deficiency.

19. The method of claim 15, wherein identifying the speed modification condition comprises identifying a speed restriction, and wherein generating the target compressor speed based at least in part on the unfiltered compressor speed and the identification of the speed modification condition comprises:
limiting the unfiltered compressor speed at an upper speed boundary based on the identification of the speed restriction.

20. The method of claim 15, wherein identifying the speed modification condition comprises identifying one or more resonance avoidance zones, and wherein generating the target compressor speed based at least in part on the unfiltered compressor speed and the identification of the speed modification condition comprises:
adjusting the unfiltered compressor speed to avoid the one or more resonance avoidance zones.
